(19) United States
(12) Patent Application Publication
(10) Pub. No.: US 2025/0012307 A1
(43) Pub. Date: Jan. 9, 2025

(54) FASTENING STRUCTURE AND FASTENING METHOD THEREOF

(71) Applicant: DTECH PRECISION INDUSTRIES CO., LTD., New Taipei City (TW)

(72) Inventor: TING-JUI WANG, New Taipei City (TW)

(73) Assignee: DTECH PRECISION INDUSTRIES CO., LTD., New Taipei City (TW)

(21) Appl. No.: 18/670,735

(22) Filed: May 22, 2024

(30) Foreign Application Priority Data
Jul. 6, 2023 (TW) 112125192

(51) Int. Cl. F16B 5/02; F16B 21/06

(52) U.S. Cl. CPC F16B 5/0216; F16B 21/065

(57) ABSTRACT

A fastening structure and a fastening method thereof include a body part and a fastening part. The body part has an entering part and can be arranged at an object, and the fastening part is arranged at the body part; and a fastened object laterally enters the entering part, so as to fasten the fastening part into a fastened part of the fastened object, so that the fastened object is limited to the body part, or the fastened object is simultaneously horizontally and vertically limited by the entering part and the fastening part. Thus, the cooperation of the entering part of the body part and the fastening part can be used to complete a quick combination of at least two objects, so as to achieve the effect of repeated and quick combination and separation.

### CROSS-REFERENCE TO RELATED APPLICATION

This non-provisional application claims priority under 35 U.S.C. § 119 (a) on Patent Application No(s). 112125192 filed in Taiwan, R.O.C. on Jul. 6, 2023, the entire contents of which are hereby incorporated by reference.

### BACKGROUND OF THE INVENTION

### 1. Field of the Invention

The present disclosure relates to a fastening structure and a fastening method thereof, and in particular to a fastening structure and a fastening method thereof that can be used to repeatedly and quickly combine and separate at least two objects.

### 2. Description of the Related Art

Conventionally, coupling together at least one object requires fastening the objects together with screws.

Although the aforesaid prior art is effective in coupling together at least one object to render them inseparable, the aforesaid prior art not only fails to render the coupling process easy but its use of screws also renders the at least one object difficult to unfasten.

### BRIEF SUMMARY OF THE INVENTION

Based on at least one embodiment of the present disclosure, the disclosure provides a fastening structure and a fastening method thereof, with a view to achieving to use the cooperation of an entering part of a body part and a fastening part, and completing a quick combination of at least two objects, so as to achieve the effect of repeated and quick combination and separation.

To achieve the above objective and other objectives, the present disclosure provides a fastening structure, comprising: a body part and a fastening part. The body part is provided with an entering part; the fastening part is arranged at the body part, and the fastening part is used to fasten a fastened object that enters the entering part.

Optionally, the body part is provided with an assembling part, the assembling part is used to connect to an object by riveting, fastening, locking, welding or expanding, or the assembling part is provided with a pressure applying part and a material entering part, so as to apply pressure on the pressure applying part by external force, so that the material of the object enters the material entering part, or the assembling part is provided with an expanding part, so as to apply pressure on the expanding part by external force, so that the expanding part is expandingly connected to the object.

Optionally, the body part is provided with an anti-rotation part, or the anti-rotation part carries out anti-rotation, orientation, limiting direction, limiting position or limiting an entering position of the fastened object with the object.

Optionally, the entering part is provided with at least one setting part, or the setting part is pierced, placed, inserted or blocked on the fastened object.

Optionally, the horizontal direction or the vertical direction of the entering part is provided with at least one setting part, or the setting part is a concave part, a convex part, a perforating part, a through hole, a step part, a plane, an engaging part, a platform part or a threaded part.

In the fastening structure, an elastic component is further included, and two ends of the elastic component respectively abut against the body part and the fastening part.

Optionally, the fastening part is provided with a head, the head is movably combined with the fastening part, and a fastening height and an unfastening height are provided between the head and the body part, so that the head drives the fastening part for fastening or unfastening.

Optionally, the fastening part is a cylinder body, rod body, threaded body, outer fastening body, inner fastening body or elastic fastening body.

Optionally, the fastening part is provided with a head and a lateral motion component, the lateral motion component is provided with a sliding part, the lateral motion component moves laterally and drives the head with the sliding part, so that the head links the fastening part for fastening or unfastening.

Optionally, the fastened object laterally enters the entering part, and is fastened by the fastening part.

Optionally, the fastened object is provided with a fastened part, the fastening part is fastened into the fastened part.

Optionally, the fastened object is provided with a fastened part, the fastened part is a horizontally closed structure.

Optionally, the fastened object or the object is a circuit board, a metal element, a plastic element, a heat dissipation component, an IC, a housing or a cabinet.

The disclosure further provides a fastening method of a fastening structure, wherein the fastened object laterally enters the lateral entering part of the body part, so as to fasten the fastening part into the fastened part of the fastened object, so that the fastened object is limited to the body part, or the fastened object is horizontally and vertically limited with the entering part and the fastening part.

### BRIEF DESCRIPTION OF THE DRAWINGS

In order to more clearly illustrate the embodiments of the present disclosure or the technical solutions in the prior art, the drawings to be used in the description of the embodiments will be briefly introduced below, and it is obvious that the drawings in the following description are only some embodiments of the present disclosure, and for those skilled in the art, other drawings can also be obtained according to these drawings without paying creative labor.

FIG. 1 is a schematic view of usage state of a first embodiment of the present disclosure.

FIG. 2 is a schematic view of a second embodiment of the present disclosure.

FIG. 3 is a schematic view of the second embodiment of the present disclosure.

FIG. 4 is a schematic view of the second embodiment of the present disclosure.

FIG. 5 is a schematic view of a third embodiment of the present disclosure.

FIG. 6 is a schematic view of usage state of a fourth embodiment of the present disclosure.

FIG. 7 is a schematic view of usage state of a fifth embodiment of the present disclosure.

FIG. 8 is a schematic view 1 of usage state of a sixth embodiment of the present disclosure.

FIG. 9 is a schematic view 2 of usage state of the sixth embodiment of the present disclosure.

FIG. 10 is a schematic view of different types of fastening parts of the present disclosure.

### DETAILED DESCRIPTION OF THE INVENTION

A fastening structure of the embodiments of the present disclosure will be further illustrated below with the accompanying drawings.

The aforementioned and other technical contents, characteristics and effects of the present disclosure can be clearly presented by the detailed description of preferable embodiments together with the attached drawings. It's worth mentioning that the direction terms mentioned in the following embodiments, such as: top, bottom, left, right, front or back are only referred to the direction of the drawings. Therefore, the directional terms used are intended to illustrate, not to limit the disclosure. In addition, in the following embodiments, the same or similar elements will use the same or similar reference numerals.

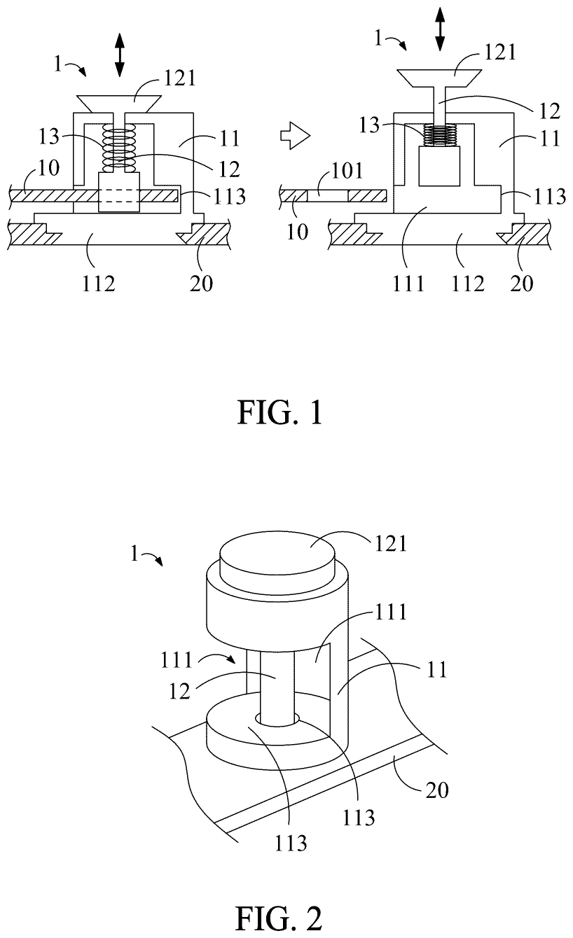

Referring to FIG. 1, as shown in the figure: the present disclosure provides a fastening structure and a fastening method thereof, and the fastening structure 1 comprises a body part 11 and a fastening part 12.

The body part 11 is provided with an entering part 111, wherein the entering part 111 is horizontally arranged at the body part 11.

The fastening part 12 is arranged at the body part 11, wherein the fastening part 12 is vertically arranged at the body part 11, the fastening part 12 is communicated to the entering part 111, and the fastening part 12 is used to fasten a fastened object 10 that enters the entering part 111.

When used, the body part 11 may be arranged on an object 20, and the fastening part 12 is fastened to the fastened object 10, wherein the fastened object 10 laterally enters the lateral entering part 111 provided by the body part 11, so as to fasten the fastening part 12 into a fastened part 101 of the fastened object 10, so that the fastened object 10 is limited to the body part 11, and the fastened object 10 is simultaneously horizontally and vertically limited by the entering part 111 and the fastening part 12, so as to complete the fastening of the fastened object 10, so that the fastened object 10 is horizontally and vertically limited with the entering part 111 and the fastening part 12; and when the fastened object 10 is to be removed, the fastening part 12 is unfastened from the fastened part 101 of the fastened object 10, and the fastened object 10 can be removed from the entering part 111. Thus, the cooperation of the entering part 111 of the body part 11 and the fastening part 12 can be used to complete a quick combination of at least two objects, so as to achieve the effect of repeated and quick combination and separation.

In addition to the above embodiment, in one embodiment of the present disclosure, the body part 11 is provided with an assembling part 112, and the assembling part 112 may be combined with the object 20 by riveting, fastening, locking, welding or expanding; in addition, the assembling part 112 may be provided with an expanding part, so as to apply pressure on the expanding part by external force, so that the expanding part is expandingly connected to the object 20. Thus, the body part 11 can be stably arranged on the object 20 to facilitate subsequent operations.

In addition to the above embodiment, in one embodiment of the present disclosure, the fastened object 10 or the object 20 may be a circuit board, a metal element, a plastic element, a heat dissipation component, an IC, a housing or a cabinet, respectively. Thus, the fastened object 10 and the object 20 can further meet the needs of practical application.

In addition to the above embodiment, in one embodiment of the present disclosure, the fastening part 12 is provided with a head 121, so that the head 121 can drive the fastening part 12 for fastening or unfastening; thus, the fastening part 12 can further meet the needs of practical application.

In addition to the above embodiment, in one embodiment of the present disclosure, the entering part 111 is provided with at least one setting part 113, and the setting part 113 can be placed (or blocked) on the fastened object 10; thus, after the fastened object 10 laterally enters the entering part 111, the fastened object 10 is placed (or blocked) at the setting part 113, so as to fasten the fastening part 12 into the fastened part 101 of the fastened object 10, so that the fastened object 10 is limited to the body part 11, and the fastened object 10 is simultaneously horizontally and vertically limited by the entering part 111 and the fastening part 12, so as to complete the fastening of the fastened object 10; and when the fastened object 10 is to be removed, the fastening part 12 is unfastened from the fastened part 101 of the fastened object 10, and the fastened object 10 can be removed from the entering part 111. Thus, the cooperation of the entering part 111 of the body part 11 and the fastening part 12 can be used to complete a quick combination of at least two objects, so as to achieve the effect of repeated and quick combination and separation.

In addition to the above embodiment, in one embodiment of the present disclosure, an elastic component 13 is further included, and two ends of the elastic component 13 respectively abut against the body part 11 and the fastening part 12; it can be automatically reset after the fastening part 12 completes the action of fastening or unfastening through the elastic abutting of the elastic component 13, so as to achieve the effect of easy operation and use.

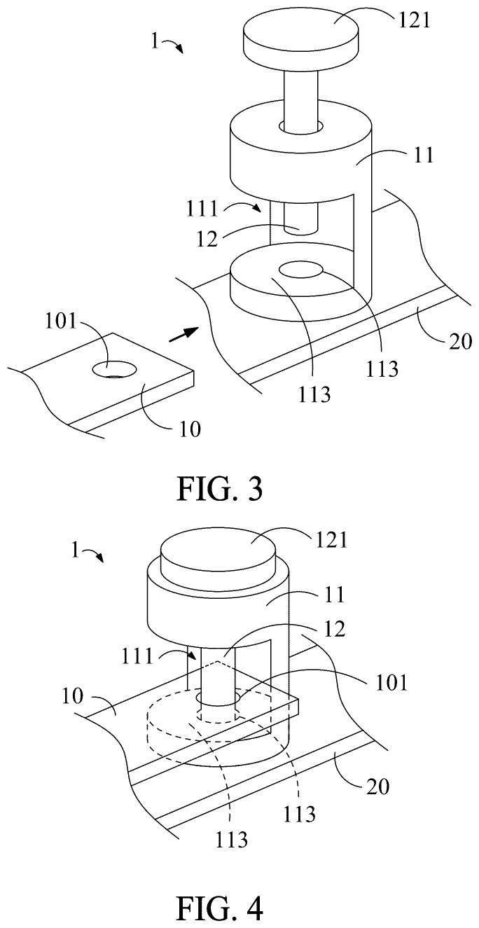

Referring to FIG. 2 to FIG. 4, as shown in the figures: in addition to the above embodiment, in one embodiment of the present disclosure, the entering part 111 is provided with at least one setting part 113, the number of the setting part 113 of the present disclosure is two, one of the setting parts 113 can be pierced (or inserted) into the fastening part 12, and the other setting part 113 can be placed (or blocked) on the fastened object 10, for example: in the present embodiment, the entering part 111 may be respectively provided with a setting part 113 at the horizontal position and the vertical position, the setting part 113 arranged in the vertical direction can be pierced (or inserted) into the fastening part 12, and the setting part 113 arranged in the horizontal direction can be placed (or blocked) on the fastened object 10.

Based on the above embodiment, when used, the fastened object 10 may be laterally arranged at the entering part 111, so that the fastened object 10 is placed (or blocked) at the horizontal setting part 113, and after the fastened part 101 of the fastened object 10 is fastened with the fastening part 12, the fastening part 12 can be pierced (or inserted) into the vertical setting part 113, so that the fastened object 10 is limited to the body part 11, and the fastened object 10 is simultaneously horizontally and vertically limited by the entering part 111 and the fastening part 12, so as to complete the fastening of the fastened object 10; and when the fastened object 10 is to be removed, the fastening part 12 is unfastened from the fastened part 101 of the fastened object 10 and the vertical setting part 113, and the fastened object 10 can be removed from the horizontal setting part 113 of the entering part 111. Thus, the cooperation of the entering part 111 of the body part 11 and the fastening part 12 can be used to complete a quick combination of at least two objects, so as to achieve the effect of repeated and quick combination and separation.

In addition to the above embodiment, in one embodiment of the present disclosure, each setting part 113 may be a concave part, a convex part, a perforating part, a through hole, a step part, a plane, an engaging part, a platform part or a threaded part; thus, each setting part 113 can further meet the needs of practical application.

In addition to the above embodiment, in one embodiment of the present disclosure, the fastened part 101 of the fastened object 10 may be a horizontally closed structure; thus, the fastened object 10 can further meet the needs of practical application.

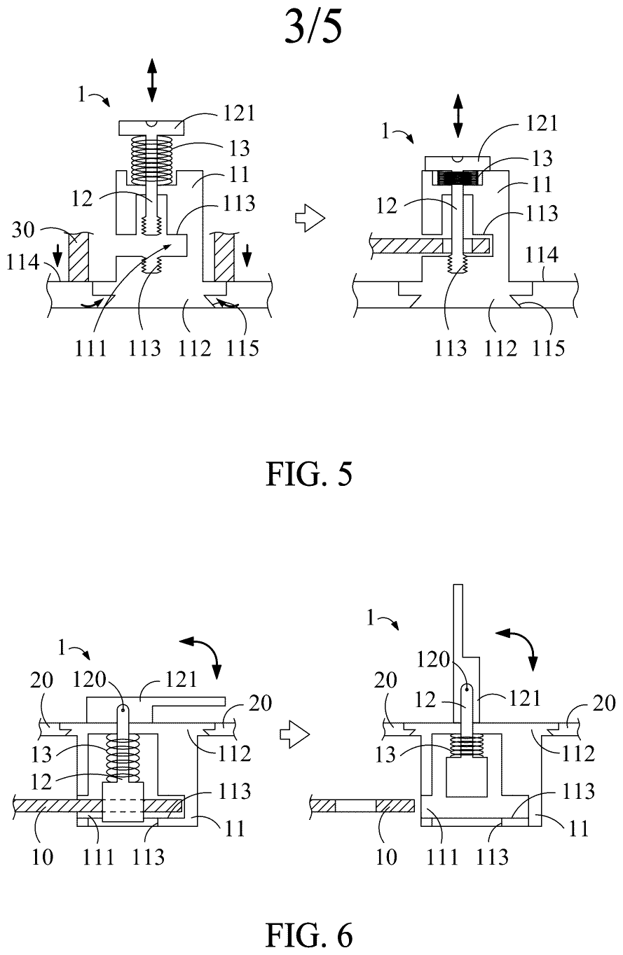

Referring to FIG. 5, as shown in the figure, in addition to the above embodiment, in one embodiment of the present disclosure, the assembling part 112 is provided with a pressure applying part 114 and a material entering part 115, so as to apply pressure on the pressure applying part 114 with external force by a tool 30, so that the material of the object 20 enters the material entering part 115. Thus, the body part 11 can be stably arranged on the object 20 to facilitate subsequent operations.

Referring to FIG. 6, as shown in the figure, in addition to the above embodiment, in one embodiment of the present disclosure, the fastening part 12 is provided with a head 121, the head 121 is movably combined with the fastening part 12 by a bolt body 120, and a fastening height h1 and an unfastening height h2 are provided between the head 121 and the body part 11, so that the head 121 drives the fastening part 12 for fastening or unfastening.

Based on the above embodiment, when used, the fastened object 10 may be laterally arranged at the entering part 111, so that the fastened object 10 is placed (or blocked) at the horizontal setting part 113, and after the head 121 is located at the fastening height h1 to make the head 121 drive the fastening part 12 for fastening to fasten the fastened part 101 of the fastened object 10, the fastening part 12 can be pierced (or inserted) into the vertical setting part 113, so that the fastened object 10 is limited to the body part 11, and the fastened object 10 is simultaneously horizontally and vertically limited by the entering part 111 and the fastening part 12, so as to complete the fastening of the fastened object 10; and when the fastened object 10 is to be removed, the head 121 drives the fastening part 12 to be located at the unfastening height h2, and the fastening part 12 is unfastened from the fastened part 101 of the fastened object 10 and the vertical setting part 113, and the fastened object 10 can be removed from the horizontal setting part 113 of the entering part 111. Thus, the cooperation of the entering part 111 of the body part 11 and the fastening part 12 can be used to complete a quick combination of at least two objects, so as to achieve the effect of repeated and quick combination and separation.

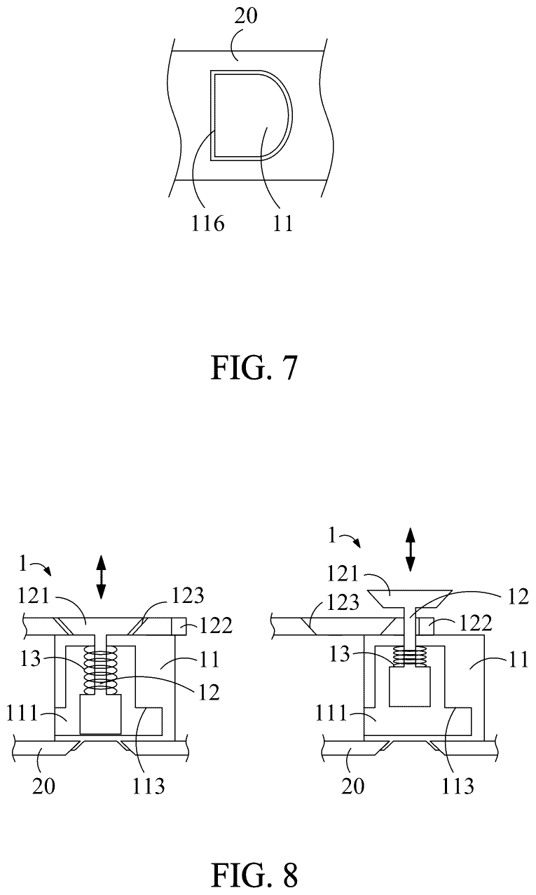

Referring to FIG. 7, as shown in the figure, in addition to the above embodiment, in one embodiment of the present disclosure, the body part 11 is provided with an anti-rotation part 116, and the anti-rotation part 116 cooperates with the object 20 to carry out anti-rotation, orientation, limiting direction, limiting position or limiting an entering position of the fastened object 10; thus, the combination of the body part 11 and the object 20 can further meet the needs of practical application.

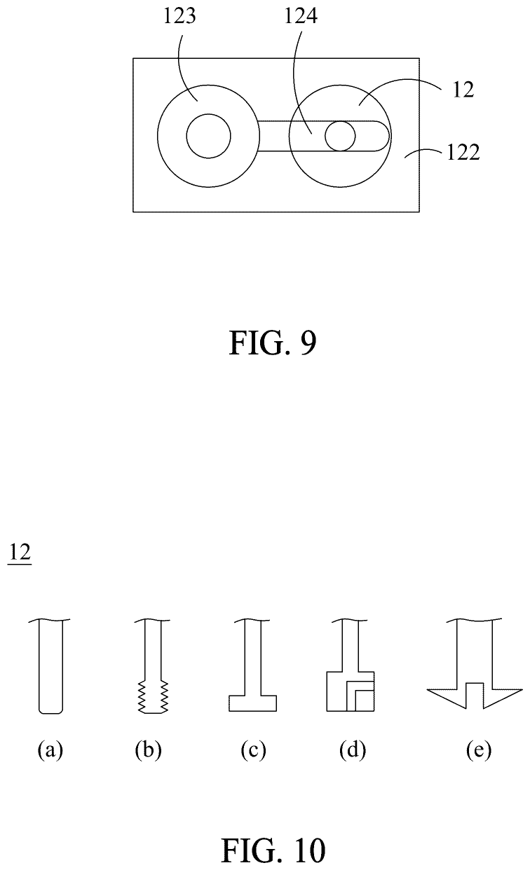

Referring to FIG. 8 and FIG. 9, as shown in the figures, in addition to the above embodiment, in one embodiment of the present disclosure, the fastening part 12 is provided with a head 121 and a lateral motion component 122, the lateral motion component 122 is provided with a sliding part 123, wherein the lateral motion component 122 is provided with a moving track 124, the sliding part 123 moves in the moving track 124, and the head 121 and the sliding part 123 are driven by an inclined plane abutting and pushing therebetween, and the lateral motion component 122 moves laterally and drives the head 121 with the sliding part 123, so that the head 121 links the fastening part 12 for fastening or unfastening; thus, the fastening part 12 can use the mutual cooperation of the head 121, the lateral motion component 122 and the sliding part 123, and can further meet the needs of practical application.

Referring to FIG. 10, as shown in the figure, in addition to the above embodiment, in one embodiment of the present disclosure, the fastening part 12 may be a cylinder body (as shown in part a of FIG. 10), rod body, threaded body (as shown in part b of FIG. 10), outer fastening body (as shown in part c of FIG. 10), inner fastening body (as shown in part d of FIG. 10) or elastic fastening body (as shown in part e of FIG. 10); thus, the fastening part 12 can be fastened or unfastened as required in response to different fastened objects 10, so that it can further meet the needs of practical application.

To sum up, the fastening structure and the fastening method thereof of the present disclosure can use the cooperation of the entering part of the body part and the fastening part to complete a quick combination of at least two objects, so as to achieve the effect of repeated and quick combination and separation.

While the present disclosure has been described by means of specific embodiments, numerous modifications and variations could be made thereto by those skilled in the art without departing from the scope and spirit of the present disclosure set forth in the claims.

What is claimed is:

1. A fastening structure, comprising:
a body part, provided with an entering part; and
a fastening part, arranged at the body part, the fastening part is used to fasten a fastened object that enters the entering part.

2. The fastening structure according to claim 1, wherein the body part is provided with an assembling part, the assembling part is used to connect to an object by riveting, fastening, locking, welding or expanding, or the assembling part is provided with a pressure applying part and a material entering part, so as to apply pressure on the pressure applying part by external force, so that the material of the object enters the material entering part, or the assembling part is provided with an expanding part, so as to apply pressure on the expanding part by external force, so that the expanding part is expandingly connected to the object.

3. The fastening structure according to claim 1, wherein the body part is provided with an anti-rotation part, or the anti-rotation part carries out anti-rotation, orientation, limiting direction, limiting position or limiting an entering position of the fastened object with the object.

4. The fastening structure according to claim 1, wherein the entering part is provided with at least one setting part, or the setting part is pierced, placed, inserted or blocked on the fastened object.

5. The fastening structure according to claim 1, wherein the horizontal direction or the vertical direction of the entering part is provided with at least one setting part, or the setting part is a concave part, a convex part, a perforating part, a through hole, a step part, a plane, an engaging part, a platform part or a threaded part.

6. The fastening structure according to claim 1, wherein an elastic component is further included, and two ends of the elastic component respectively abut against the body part and the fastening part.

7. The fastening structure according to claim 1, wherein the fastening part is provided with a head, the head is movably combined with the fastening part, and a fastening height and an unfastening height are provided between the head and the body part, so that the head drives the fastening part for fastening or unfastening.

8. The fastening structure according to claim 1, wherein the fastening part is a cylinder body, rod body, threaded body, outer fastening body, inner fastening body or elastic fastening body.

9. The fastening structure according to claim 1, wherein the fastening part is provided with a head and a lateral motion component, the lateral motion component is provided with a sliding part, the lateral motion component moves laterally and drives the head with the sliding part, so that the head links the fastening part for fastening or unfastening.

10. The fastening structure according to claim 1, wherein the fastened object laterally enters the entering part, and is fastened by the fastening part.

11. The fastening structure according to claim 1, characterized in that the fastened object is provided with a fastened part, the fastening part is fastened into the fastened part.

12. The fastening structure according to claim 1, wherein the fastened object is provided with a fastened part, the fastened part is a horizontally closed structure.

13. The fastening structure according to claim 1, wherein the fastened object or the object is a circuit board, a metal element, a plastic element, a heat dissipation component, an IC, a housing or a cabinet.

14. A fastening method of a fastening structure, using the fastening structure according to claim 1 for fastening, wherein the fastened object laterally enters the lateral entering part of the body part, so as to fasten the fastening part into the fastened part of the fastened object, so that the fastened object is limited to the body part, or the fastened object is horizontally and vertically limited with the entering part and the fastening part.
